(19) United States
(12) Patent Application Publication
(10) Pub. No.: US 2026/0322037 A1
(43) Pub. Date: Oct. 15, 2026

(54) CONNECTOR ASSEMBLY

(71) Applicant: JAPAN AVIATION ELECTRONICS INDUSTRY, LIMITED, Tokyo (JP)

(72) Inventor: Satoru TAKIZAWA, Tokyo (JP)

(73) Assignee: JAPAN AVIATION ELECTRONICS INDUSTRY, LIMITED, Tokyo (JP)

(21) Appl. No.: 19/467,920

(22) Filed: Feb. 3, 2026

(30) Foreign Application Priority Data
Mar. 14, 2025 (JP) 2025-041581

(51) Int. Cl. H01R 13/645; H01R 12/72; H01R 12/75; H01R 13/629; H01R 27/02

(52) U.S. Cl. CPC H01R 13/6456; H01R 12/724; H01R 12/727; H01R 12/75; H01R 13/62955; H01R 27/02

(57) ABSTRACT

In a first connector, plural types of first internal modules have first internal housings, respectively, which have first main portions with the same shape. In a second connector, plural types of second internal modules have second internal housings, respectively, which have second main portions with the same shape. The types of the second internal modules correspond to the types of the first internal modules. Leading ends of the second internal housings of the second internal modules are positioned at the same positions as each other in a mating direction. When each of the second internal modules is mated with the first internal module of the type corresponding thereto, a second key of the second internal housing fits with a first key of the first internal module of the type corresponding to the second internal module.

### CROSS REFERENCE TO RELATED APPLICATIONS

This application is based on and claims priority under 35 U.S.C. § 119 to Japanese Patent Application No. JP2025-041581 filed Mar. 14, 2025, the contents of which are incorporated herein in their entirety by reference.

### BACKGROUND OF THE INVENTION

This invention relates to a connector assembly, in particular, to a connector assembly provided with a structure in which an external housing holds a plurality of internal modules.

A connector assembly having a structure in which an external housing holds a plurality of internal modules is known as a connector assembly provided with a plug connector and a receptacle connector. Such a connector assembly is disclosed, for example, in US 2023/0246379 A1 (Patent Document 1).

As shown in FIG. 12, a connector assembly 90 disclosed in Patent Document 1 is provided with an electrical connector 92 and a corresponding electrical connector 94. The electrical connector 92 has a plurality of terminal modules 921 and a frame 923 which holds the terminal modules 921. The corresponding electrical connector 94 has a plurality of terminal modules 941 corresponding to the terminal modules 921, respectively, and a frame 943 which holds the terminal modules 941.

As understood from FIG. 12, the terminal modules 921 of the electrical connector 92 are different from one another in type. In detail, each of the terminal modules has terminals, and the terminal modules are different from one another in the shape of the terminals and in number and arrangement of terminals. The terminal modules 941 of the corresponding electrical connector 94 correspond to the terminal modules 921 of the electrical connector 92, respectively.

As understood from FIG. 12, the frame 923 of the electrical connector 92 is provided with module bays for receiving the terminal modules 921, respectively. The module bays of the frame 923 have shapes same as one another. The terminal modules 921 have shapes same as one another at least in part so that each of them can be received by any one of the module bays of the frame 923. The frame 943 of the corresponding electrical connector 94 is also provided with module bays for receiving the terminal modules 941, respectively. The module bays of the frame 943 also have shapes same as one another. The terminal modules 941 have shapes same as one another at least in part so that each of them can be received by any one of the module bays of the frame 943.

The connector assembly 90 of Patent Document 1 allows the types and the positions of the terminal modules 921 of the electrical connector 92 and the types and the positions of the terminal modules 941 of the corresponding electrical connector 94 to be changed depending on the intended use. However, such a structure has a possibility that the terminal modules 921 of the electrical connector 92 and the terminal modules 941 of the electrical connector 94 might be mistakenly used in type or in position. When the types and the positions of the terminal modules 921 of the electrical connector 92 do not correspond to the types and the positions of the terminal modules 941 of the corresponding electrical connector 94, the electrical connector 92 cannot be mated with the corresponding electrical connector 94. In spite of that, when a user forcibly tries to mate the electrical connector 92 with the corresponding electrical connector 94, the electrical connector 92 and the corresponding electrical connector 94 are possible to be damaged. In particular, when a booster mechanism, which assists a mating by operating a mating lever 96, is provided as the connector assembly 90 of Patent Document 1, the possibility that the electrical connector 92 and the corresponding electrical connector 94 are damaged will be remarkably increased.

### SUMMARY OF THE INVENTION

It is therefore an object of the present invention to provide a connector assembly which reduces a possibility that connectors are damaged by trying to forcibly mate the connectors with each other when types and positions of terminal modules in one of the connectors are different from types and positions of terminal modules in the other of the connectors.

One aspect of the present invention provides a connector assembly comprising a first connector and a second connector which is mateable with the first connector in a predetermined direction. The first connector comprises a first external housing and a plurality of types of first internal modules. The first external housing is provided with a plurality of first bays. The first internal modules are received by the first bays, respectively. Each of the first internal modules comprises a first internal housing and a first terminal held by the first internal housing. The first internal housing has a first main portion and a first key. The first main portions of the first internal modules have shapes same as each other. The first main portions are received by the first bays, respectively, and held by the first external housing. The second connector comprises a second external housing and a plurality of types of second internal modules. The second external housing is provided with a plurality of second bays. The types of the second internal modules correspond to the types of the first internal modules. When the first connector is mated with the second connector, each of the second internal modules is mated with the first internal module of the type corresponding thereto. The second internal modules are received by the second bays, respectively. Each of the second internal modules comprises a second internal housing and a second terminal held by the second internal housing. When each of the second internal modules is mated with the first internal module of the type corresponding thereto, the second terminal of the second internal module is connected to the first terminal of the first internal module of the type corresponding to the second internal module. The second internal housing has a second main portion and a second key. The second main portions of the second internal modules have shapes same as each other. The second main portions are received by the second bays, respectively, and held by the second external housing. Leading ends of the second internal housings of the second internal modules are positioned at positions same as each other in the predetermined direction. The second key reaches the leading end of the second internal housing. When each of the second internal modules is mated with the first internal module of the type corresponding thereto, the second key of the second internal module fits with the first key of the first internal module of the type corresponding to the second internal module.

In the connector assembly of the above-mentioned aspect, the leading ends of the second internal housings of the second internal modules are same as each other in position in the predetermined direction. With this structure, if the first internal module does not correspond to the second internal module, the leading end of the second internal housing is brought into abutment with the leading end of the first internal housing when the first connector is tried to be mated with the second connector, so that a user can know that. In addition, the first connector cannot be mated with the second connector. As a result, it can be avoided that the first connector and the second connector are damaged by a forced mating of them.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a connector assembly according to an embodiment of the present invention. A first connector and a second connector are not mated with each other.

FIG. 2 is another perspective view showing the connector assembly of FIG. 1. The first connector and the second connector are in a preliminary mated state.

FIG. 3 is yet another perspective view showing the connector assembly of FIG. 1. The first connector and the second connector are mated with each other.

FIG. 4 is a perspective view showing a first connector included in the connector assembly of FIG. 1.

FIG. 5 is an exploded, perspective view showing the first connector of FIG. 4.

FIG. 6 is a front view showing the first connector of FIG. 4.

FIG. 7 is a plan view showing the first connector of FIG. 4.

FIG. 8 is a perspective view showing a second connector included in the connector assembly of FIG. 1.

FIG. 9 is an exploded, perspective view showing the second connector of FIG. 8.

FIG. 10 is a rear view showing the second connector of FIG. 8.

FIG. 11 is a plan view showing the second connector of FIG. 8.

FIG. 12 is a perspective view showing a connector assembly disclosed in Patent Document 1.

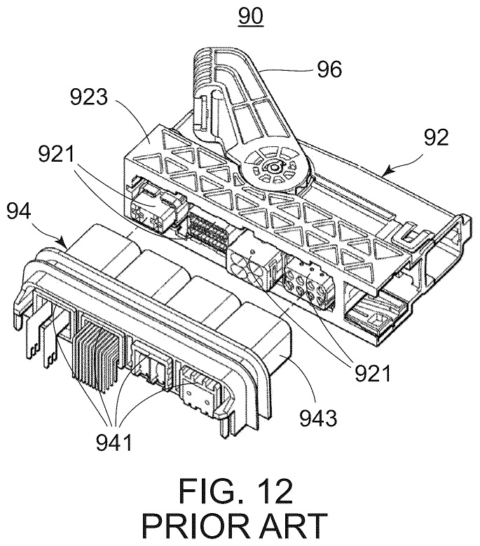

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

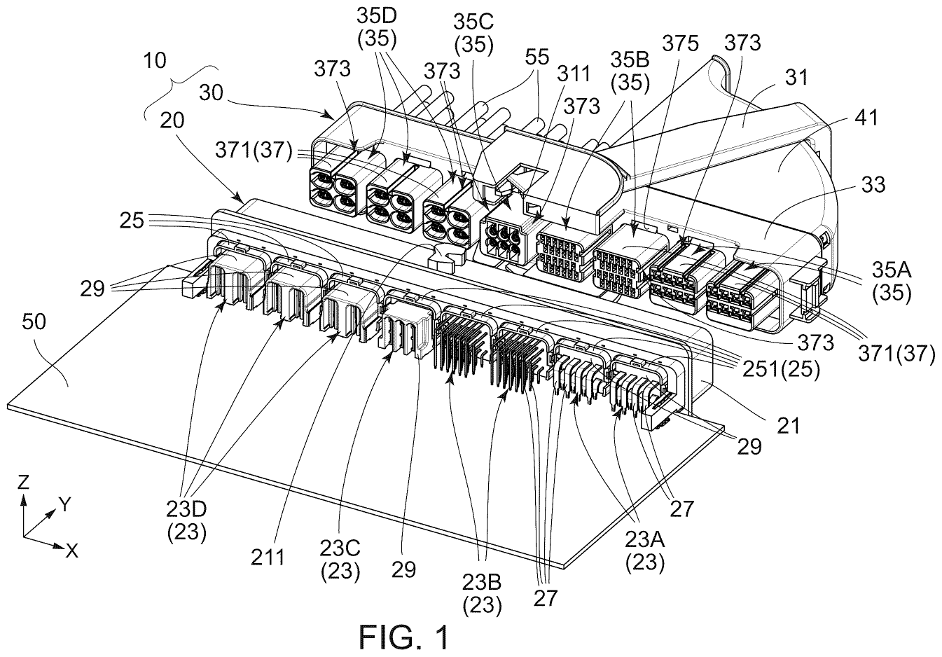

As shown in FIG. 1, a connector assembly 10 according to an embodiment of the present invention is provided with a first connector 20 and a second connector 30. In the present embodiment, the first connector 20 is a plug connector mounted on a circuit board 50. Moreover, in the present embodiment, the second connector 30 is a receptacle connector attached to an end of a cable 55. However, the present invention is not limited thereto. The first connector 20 may be formed so as to be connected to a cable. Moreover, the second connector 30 may be formed so as to be mounted on a circuit board.

As understood from FIGS. 1 to 3, the first connector 20 and the second connector 30 are mateable with each other along a predetermined direction. In the present embodiment, the predetermined direction, or a mating direction, is a front-rear direction or a Y-direction. Moreover, in the present embodiment, a positive Y-direction is directed forward while a negative Y-direction is directed rearward.

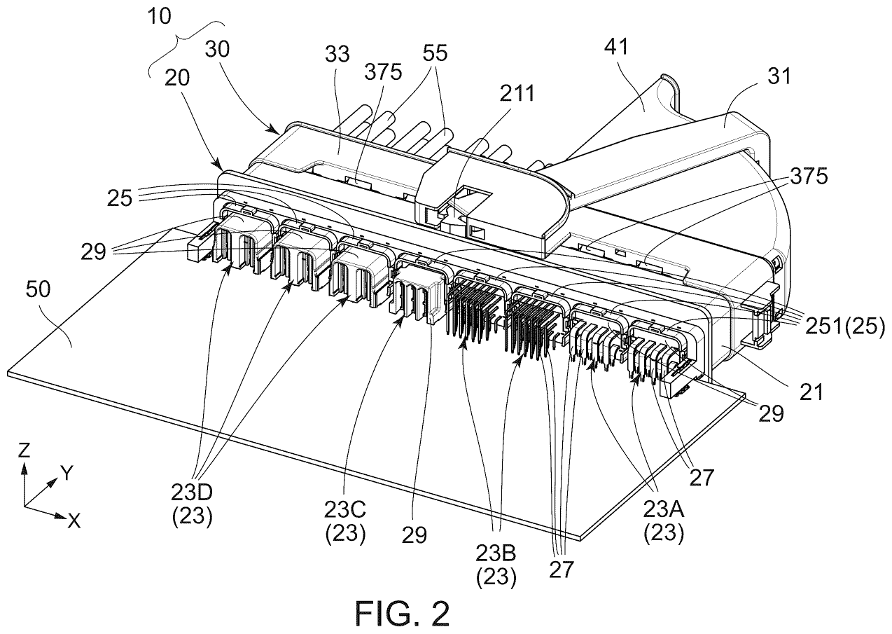

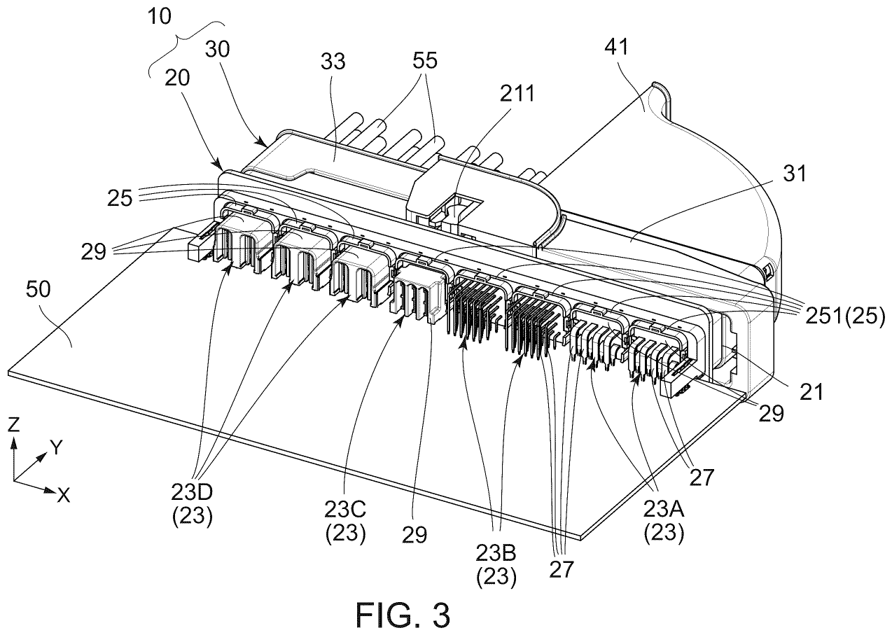

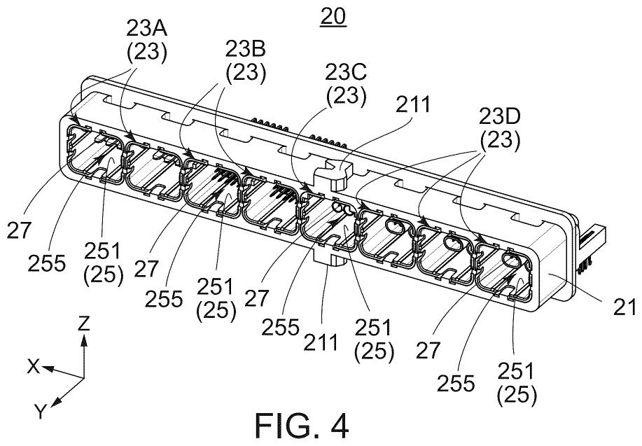

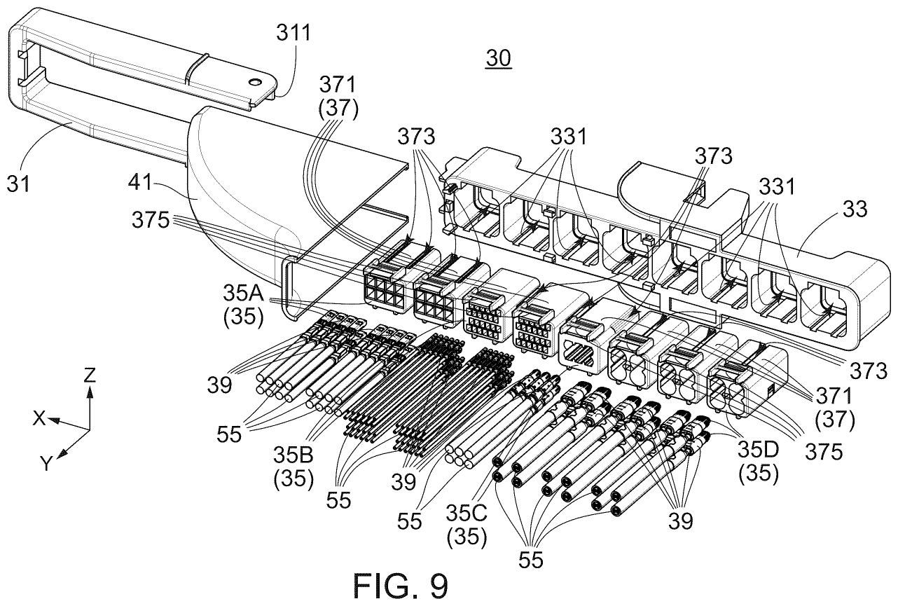

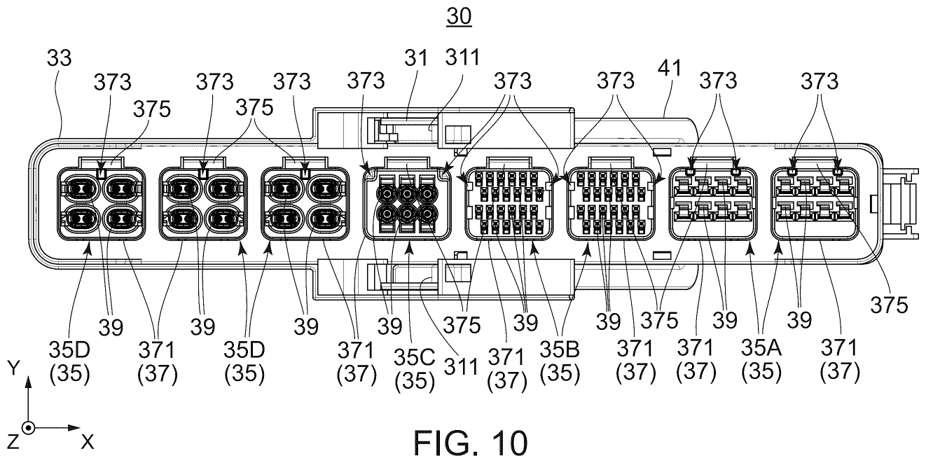

As understood from FIGS. 1 and 4, in the present embodiment, the first connector 20 is provided with a pair of rack pieces 211. Moreover, the second connector 30 is provided with a mating lever 31 having pinion teeth 311 (see FIGS. 9 and 10). The rack pieces 211 of the first connector 20 and the mating lever 31 of the second connector 30 serve as a booster mechanism which assists a mating of the first connector 20 and the second connector 30. In detail, the rack pieces 211 and the mating lever 31 facilitate a state change between a temporarily mated state shown in FIG. 2 and a mated state shown in FIG. 3 by operating the mating lever 31. Incidentally, a detailed structure of the booster mechanism having the rack pieces 211 and the pinion teeth 311 is similar to the lever mechanism disclosed in JP 2008-41417 A, for example. As just described, the connector assembly 10 of the present embodiment is provided with the booster mechanism which assists the mating of the first connector 20 and the second connector 30. However, the booster mechanism is not essential in the present invention. In addition, the structure of the booster mechanism is not particularly limited but may employ another structure, such as one using a slider.

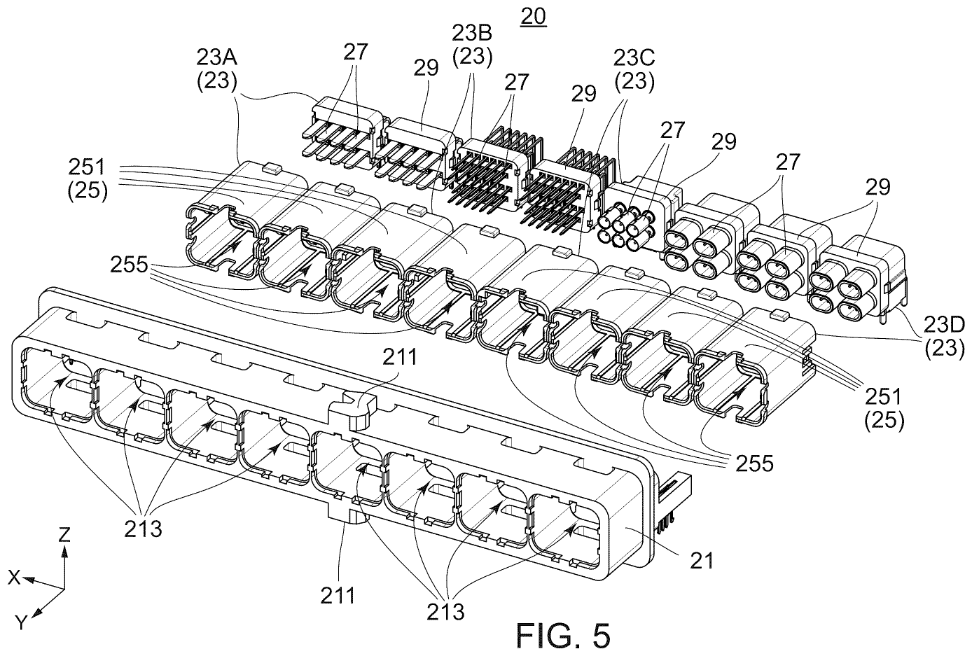

As understood from FIGS. 4 and 5, the first connector 20 is provided with a first external housing 21 and a plurality of types of first internal modules 23. The first external housing 21 is provided with a plurality of first bays 213 for receiving the first internal modules 23, respectively. The first bays 213 of the first external housing 21 are formed so as to have same shapes as each other. The first internal modules 23 are received by the first bays 213, respectively. In the present embodiment, the first bays 213 of the first external housing 21 are arranged in line. However, the present invention is not limited thereto. The first bays 213 may be arranged in two or more lines.

As shown in FIG. 5, each of the first internal modules 23 is provided with a first internal housing 25 and one or more first terminals 27 held by the first internal housing 25. In the present embodiment, the first terminals 27 are male terminals. Moreover, in the present embodiment, the first terminals 27 of each of the first internal modules 23 are held by a terminal holder 29, and indirectly held by the first internal housing 25 via the terminal holder 29. The shape, number and arrangement of the first terminals 27 of each of the first internal module 23 decide the type of the first internal module 23. In other words, the first internal modules 23 different from each other in type are different from each other in at least one of the shape, number and arrangement of the first terminals 27. In the present embodiment, the types of the first internal modules 23 are four in number. In detail, in the present embodiment, the first internal modules 23 include power modules 23A, signal modules 23B, a coaxial cable module 23C and differential signal modules 23D. However, the present invention is not limited thereto. The types and number of the first internal modules 23 may be decided depending on the intended use of the connector assembly 10.

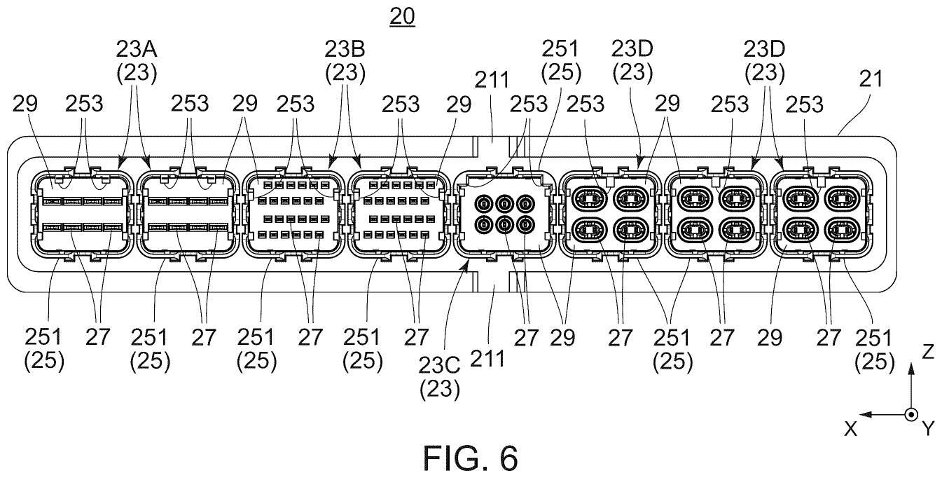

As understood from FIGS. 5 and 6, each of the first internal housings 25 has a first main portion 251 and a first key 253. The first main portion 251 has a tubular shape extending in the front-rear direction. The first main portion 251 forms a receiving portion 255 for partly receiving a second internal housing 37 mentioned later. Thus, each of the first internal housings 25 has the receiving portion 255 for partly receiving the second internal housing 37. The first main portions 251 of the first internal modules 23 have same shapes as each other. However, each of the first main portions 251 may have a portion different from the other first main portions 251, provided that it can be received by any one of the first bays 213. In other words, the first main portions 251 should have substantially same shapes as each other, and the shapes may not be identical to each other.

As understood from FIG. 6, in the present embodiment, the first key 253 consists of one or more elongated protrusions 253 which protrude inward of the first main portion 251 from an inner wall of the first main portion 251 and extend in the front-rear direction. Each of the elongated protrusions 253 may or may not reach a leading end of the first internal housing 25. In the present embodiment, each of the elongated protrusions 253 does not reach the leading end of the first internal housing 25. Combinations of positions and numbers of the elongated protrusions 253 are different from each other by the type of the first internal module 23. The elongated protrusions 253 may be individually or commonly set in size.

As shown in FIG. 6, in the present embodiment, the number of the elongated protrusions 253 of each of the power modules 23A is two, and both of the elongated protrusions 253 protrude downward from an upper wall of the first main portion 251. In the present embodiment, an up-down direction is a Z-direction. Moreover, in the present embodiment, a positive Z-direction is directed upward while a negative Z-direction is directed downward.

As shown in FIG. 6, in the present embodiment, the number of the elongated protrusions 253 of each of the signal modules 23B is two, and the elongated protrusions 253 protrude inward in a lateral direction from both side walls of the first main portion 251. In the present embodiment, the lateral direction is an X-direction.

As shown in FIG. 6, in the present embodiment, the number of the elongated protrusions 253 of the coaxial cable module 23C is two, and each of the elongated protrusions 253 protrudes inward at a boundary between an upper wall of the first main portion 251 and each side wall of the first main portion 251.

As shown in FIG. 6, in the present embodiment, the number of the elongated protrusion 253 of each of the differential signal modules 23D is one, and the elongated protrusion 253 protrudes downward from an upper wall of the first main portion 251. A protruding amount of the elongated protrusion 253 of the differential signal module 23D is larger than that of the elongated protrusion 253 of the power module 23A.

As understood from FIGS. 4 and 5, the first main portions 251 of the first internal housings 25 are received by the first bays 213 of the first external housing 21, respectively, and held by the first external housing 21. As described before, the first bays 213 have the same shapes as each other, and the first main portions 251 have the same shapes as each other. Accordingly, each of the first bays 213 can receive any one of the first internal modules 23 regardless of the types of the first internal modules 23. Therefore, each of the first internal modules 23 might be received by the first bay 213 in a wrong position. In order to prevent positioning errors of the first internal modules 23, the first internal housings 25 may be color-coded by the type of the first internal module 23. In other words, the first internal housing 25 may be formed using resin with a different color for each type of the first internal module 23.

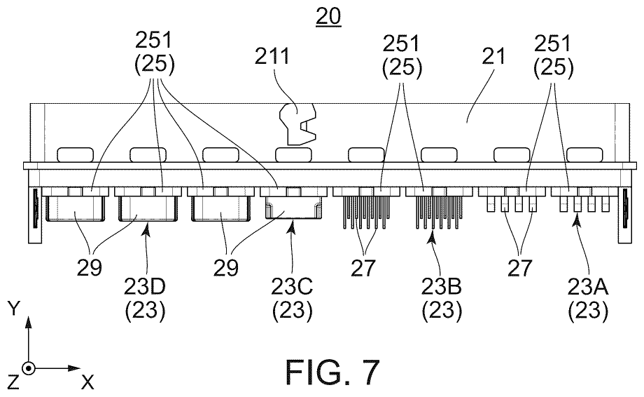

As understood from FIG. 7, in a state where the first internal modules 23 are received by the first bays 213 of the first external housing 21, the leading ends or front ends of the first internal housings 25 are not visible when viewed from above. In other words, the leading ends of the first internal housings 25 are positioned in the first external housing 21. With this structure, the leading ends of the first internal housings 25 are protected by the first external housing 21. Accordingly, even when each of the first internal housings 25 has a thin wall thickness, a possibility that the first internal housing 25 is damaged can be reduced.

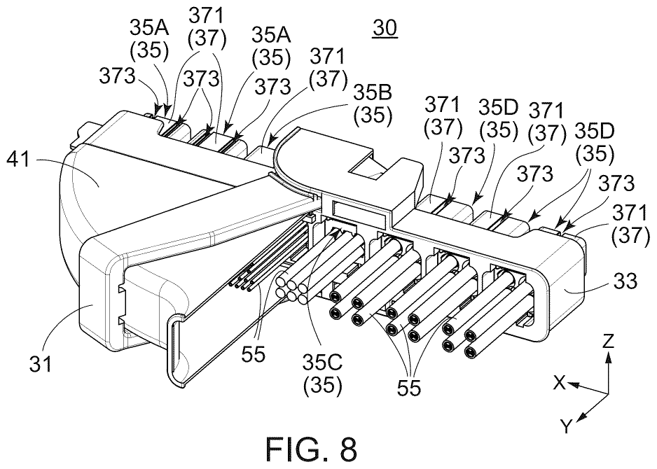

As understood from FIGS. 8 and 9, the second connector 30 is provided with a second external housing 33 and a plurality of types of second internal modules 35. In the present embodiment, the second connector 30 is further provided with the mating lever 31 and a harness cover 41.

As shown in FIG. 9, the second external housing 33 is provided with a plurality of second bays 331 for receiving the second internal modules 35, respectively. The second internal modules 35 are received by the second bays 331, respectively. In the present embodiment, the second bays 331 of the second external housing 33 are arranged in line so as to correspond to the first bays 213 of the first connector 20.

As shown in FIG. 9, each of the second internal modules 35 is provided with the second internal housing 37 and one or more second terminals 39 held by the second internal housing 37. In the present embodiment, the second terminals 39 are female terminals. Moreover, in the present embodiment, the second terminals 39 are directly held by the second internal housings 37. The shape, number and arrangement of the second terminals 39 decide the type of the second internal module 35. In other words, the second internal modules 35 different from each other in type are different from each other in at least one of the shape, number and arrangement of the second terminals 39.

As understood from FIGS. 1 to 3, the types of the second internal modules 35 of the second connector 30 correspond to the types of the first internal modules 23 of the first connector 20. When the first connector 20 and the second connector 30 are mated with each other, each of the second internal modules 35 is mated with the first internal module 23 of the type corresponding thereto. Moreover, when each of the second internal modules 35 is mated with the first internal module 23 of the type corresponding thereto, the second internal housing 37 of the second internal module 35 is received by the receiving portion 255 of the first internal housing 25 corresponding thereto. Furthermore, when each of the second internal modules 35 is mated with the first internal module 23 of the type corresponding thereto, the second terminals 39 of the second internal module 35 are connected to the first terminals 27 of the first internal module 23 of the type corresponding to the second internal module 35. In detail, in the present embodiment, the second internal modules 35 include power modules 35A, signal modules 35B, a coaxial cable module 35C and differential signal modules 35D. The power modules 35A, which are the second internal modules 35, are mated with the power modules 23A, which are the first internal modules 23. The signal modules 35B, which are the second internal modules 35, are mated with the signal modules 23B, which are the first internal modules 23. The coaxial cable module 35C, which is the second internal module 35, is mated with the coaxial cable module 23C, which is the first internal module 23. The differential signal modules 35D, which are the second internal modules 35, are mated with the differential signal modules 23D, which are the first internal modules 23.

As understood from FIGS. 9 and 10, each of the second internal housings 37 has a second main portion 371 and a second key 373. The second main portion 371 is a part of the second internal housing 37 or an outer periphery wall part having a tubular shape extending in the front-rear direction. The second main portions 371 of the second internal modules 35 have same shapes as each other. However, each of the second main portions 371 may be different from others of the second main portions 371, provided that it can be received by any one of the second bays 331. In other words, the second main portions 371 should have substantially same shapes as each other, and the shapes may not be identical to each other.

As understood from FIG. 10, in the present embodiment, the second key 373 consists of one or more grooves 373 which are formed in an outer surface of the second main portion 371 and extend in the front-rear direction. The grooves 373 extend from the leading ends or rear ends of the second main portion 371 or the second internal housings 37 toward an internal part of the second main portion 371 or forward. In other words, the grooves 373 reach the leading ends of the second main portion 371 or the second internal housing 37. Combinations of positions and numbers of the grooves 373 are different from each other by the type of the second internal module 35. When the type of the first internal module 23 and the type of the second internal module 35 correspond to each other, the first key 253 of the first internal module 23 and the second key 373 of the second internal module 35 correspond to each other. In detail, the positions and number of the elongated protrusions 253 correspond to the positions and number of the grooves 373, and sizes of the elongated protrusions 253 correspond to sizes of the grooves 373. In other words, each of the grooves 373 has a size which can receive the elongated protrusion 253 corresponding thereto. Accordingly, when each of the second internal modules 35 is mated with the first internal module 23 of the type corresponding thereto, the second key 373 of the second internal module 35 is fitted to the first key 253 of the first internal module 23 of the type corresponding to the second internal module 35.

As shown in FIG. 9, each of the second internal housings 37 is provided with a locking portion 375. When the second internal module 35 is received by the second bay 331 of the second external housing 33, the locking portion 375 is brought into engagement with a locked portion (not shown) of the second external housing 33 and prevents the second internal module 35 from being removed from the second bay 331. On the other hand, when the locking portion 375 is operated, it allows the second internal module 35 to be removed from the second bay 331. Thus, in the present embodiment, the second internal modules 35 are received by the second bays 331 so as to be removable from the second bays 331.

As understood from FIGS. 9 and 10, the second main portions 371 of the second internal housings 37 are received by the second bays 331 of the second external housing 33 and held by the second external housing 33. Similarly to the first connector 20, each of the second bays 331 can receive any one of the second internal modules 35 regardless of the types of the second internal modules 35. Accordingly, each of the second internal modules 35 might be received by the second bay 331 in a wrong position. Therefore, also for the second internal modules 35, the second internal housings 37 may be color-coded by the type of the second internal module 35. In that case, it is preferable that the color of the second internal housing 37 is same as the color of the first internal housing 25 of the type corresponding thereto.

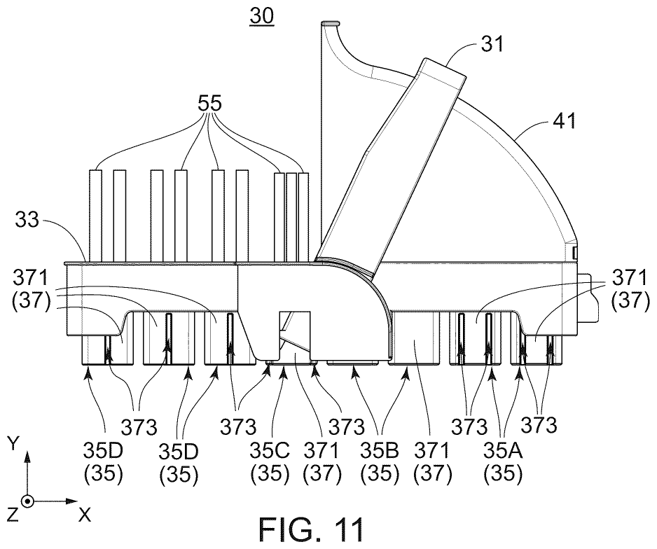

As shown in FIG. 11, when the second internal modules 35 are received by the second bays 331 of the second external housing 33, each of the leading ends or rear ends of the second internal housings 37 protrudes from the second external housing 33. Accordingly, each of the leading ends of the second internal housings 37 is visible when viewed from above. Moreover, the leading ends of the second internal housings 37 are same as each other in position in the front-rear direction. Accordingly, when the first connector 20 and the second connector 30 are mated with each other, all of the leading ends of the second internal housings 37 can be simultaneously received by the receiving portions 255 of the first internal housings 25. On the other hand, it does not occur that one or more of the second internal housings 37 are received by the receiving portions 255 of the first internal housings 25 corresponding thereto before others of the second internal housings 37 are received by the receiving portions 255 of the first internal housings 25 corresponding thereto.

As understood from FIGS. 1 to 3, when the types of the second internal modules 35 of the second connector 30 correspond to the types of the first internal modules 23, which are positioned at positions corresponding thereto, of the first connector 20, respectively, the first connector 20 and the second connector 30 are mateable with each other. On the other hand, even when only one of the types of the second internal modules 35 of the second connector 30 does not correspond to the type of the first internal module 23, which is positioned at the position corresponding thereto, of the first connector 20, the first connector 20 and the second connector 30 cannot be mated with each other. This is because of a function of the first keys 253 of the first internal housings 25 and the second keys 373 of the second internal housings 37. At this time, even when there is only one pair of the first internal housing 25 and the second internal housing 37 which do not correspond to each other in type, the leading ends of the second internal housings 37 cannot be inserted into the receiving portions 255 of the first internal housings 25 at all. Thus, the first connector 20 and the second connector 30 cannot be mated with each other. This is because all of the leading ends of the second internal housings 37 are positioned at same positions as each other in the front-rear direction. With this structure, it is prevented that a user mistakenly decides that the first connector 20 and the second connector 30 are mateable based on that some of the leading ends of the second internal housing 37 are received by the receiving portions 255 of the first internal housings 25. As a result, the connector assembly 10 is prevented from being damaged by forcibly mating the first connector 20 and the second connector 30 with each other. This is particularly effective for a connector assembly provided with a booster mechanism, such as the connector assembly 10 of the present embodiment.

Although the specific explanation about the present invention is made above with reference to concrete embodiments, the present invention is not limited thereto but susceptible of various modifications and alternative forms without departing from the spirit of the invention. For example, although the first key 253 consists of the elongated protrusion(s) and the second key 373 consists of the groove(s) in the aforementioned embodiment, the present invention is not limited thereto. In one example, front portions of the second main portions 371 may have the same shape so as to be held by the second bays 331 while rear portions of the second main portion 371 may have different shapes by type. In that case, the receiving portions 255 of the first keys 253 may have different shapes by the type.

Although the first connector 20 is a right-angle type connector of which a mating direction is parallel with the circuit board 50, it may be a straight type connector of which a mating direction is perpendicular to the circuit board 50. When the first connector 20 is the straight type connector, the first internal modules 23 of the first connector 20 may be arranged in two or more rows or in a matrix. In this case, the second connector 30 should be formed so as to correspond to the first connector 20.

Although, in the aforementioned embodiment, the first connector 20 mounted on the circuit board 50 is the plug connector while the second connector 30 connected to the cable 55 is the receptacle connector, the first connector 20 mounted on the circuit board 50 may be formed as the receptacle connector while the second connector 30 connected to the cable 55 may be formed as the plug connector.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly comprising a first connector and a second connector which is mateable with the first connector in a predetermined direction, wherein:
the first connector comprises a first external housing and a plurality of types of first internal modules;
the first external housing is provided with a plurality of first bays;
the first internal modules are received by the first bays, respectively;
each of the first internal modules comprises a first internal housing and a first terminal held by the first internal housing;
the first internal housing has a first main portion and a first key;
the first main portions of the first internal modules have shapes same as each other;
the first main portions are received by the first bays, respectively, and held by the first external housing;
the second connector comprises a second external housing and a plurality of types of second internal modules;
the second external housing is provided with a plurality of second bays;
the types of the second internal modules correspond to the types of the first internal modules;
when the first connector is mated with the second connector, each of the second internal modules is mated with the first internal module of the type corresponding thereto;
the second internal modules are received by the second bays, respectively;
each of the second internal modules comprises a second internal housing and a second terminal held by the second internal housing;
when each of the second internal modules is mated with the first internal module of the type corresponding thereto, the second terminal of the second internal module is connected to the first terminal of the first internal module of the type corresponding to the second internal module;
the second internal housing has a second main portion and a second key;
the second main portions of the second internal modules have shapes same as each other;
the second main portions are received by the second bays, respectively, and held by the second external housing;
leading ends of the second internal housings of the second internal modules are positioned at positions same as each other in the predetermined direction;
the second key reaches the leading end of the second internal housing; and
when each of the second internal modules is mated with the first internal module of the type corresponding thereto, the second key of the second internal module fits with the first key of the first internal module of the type corresponding to the second internal module.

2. The connector assembly as recited in claim 1, wherein in at least one of a group of the first internal modules and a group of the second internal modules, the first internal modules or the second internal modules are color-coded by the types.

3. The connector assembly as recited in claim 1, wherein the first keys are different by the types of the first internal modules.

4. The connector assembly as recited in claim 3, wherein:
the first key comprises at least one elongated protrusion and has a combination of a number of the at least one elongated protrusion and a position of the at least one elongated protrusion different by the types of the first internal modules;
the second key comprises at least one groove able to receive the first key corresponding thereto; and
the at least one groove extends from the leading end of the second internal housing toward an internal part of the second internal housing.

5. The connector assembly as recited in claim 1, wherein the connector assembly further comprises a booster mechanism which assists a mating of the first connector and the second connector.

6. The connector assembly as recited in claim 1, wherein the second internal modules are received by the second bays so as to be removable from the second bays.

7. The connector assembly as recited in claim 1, wherein:
the first internal housing has a receiving portion;
the leading end of the second internal housing protrudes from the second external housing and is visible when viewed from above; and
when each of the second internal modules is mated with the first internal module of the type corresponding thereto, the second internal housing of the second internal module is received by the receiving portion of the first internal housing corresponding to the second internal housing.

8. The connector assembly as recited in claim 1, wherein a leading end of the first internal housing is positioned in the first external housing.
